(19) United States
(12) Patent Application Publication
(10) Pub. No.: US 2025/0260756 A1
(43) Pub. Date: Aug. 14, 2025

(54) METHOD AND APPARATUS FOR TRANSMITTING AND RECEIVING SIGNAL INCLUDING PAYLOAD HEADER IN WIRELESS COMMUNICATION SYSTEM

(71) Applicant: Samsung Electronics Co., Ltd., Gyeonggi-do (KR)

(72) Inventors: Miao ZHOU, Beijing (CN); Feifei SUN, Beijing (CN); Di SU, Beijing (CN)

(21) Appl. No.: 19/048,143

(22) Filed: Feb. 7, 2025

(30) Foreign Application Priority Data
Feb. 8, 2024 (CN) 202410178010.8
May 8, 2024 (CN) 202410565928.8

(51) Int. Cl. H04L 69/22

(52) U.S. Cl. CPC H04L 69/22

(57) ABSTRACT

The disclosure relates to a 5G or 6G communication system for supporting a higher data transmission rate. Disclosed is a method performed by a user equipment (UE) in an AIT (Ambient Internet of Things) system, including receiving at least one payload header in a downlink signal, wherein the at least one payload header includes information related to an identity of the UE, and receiving at least one payload corresponding to the at least one payload header in the downlink signal based on the information related to the identity of the UE.

### CROSS-REFERENCE TO RELATED APPLICATION(S)

This application is based on and claims priority under 35 U.S.C. § 119 to Chinese Patent Application Nos. 202410178010.8 and 202410565928.8, filed in the Chinese Patent Office on Feb. 8, 2024, and May 8, 2024, respectively, the disclosures of which are incorporated herein by reference in their entireties.

### BACKGROUND

### 1. Field

The disclosure relates generally to the field of wireless communication, and more particularly, to a method and an apparatus for transmitting and receiving a signal including a payload header in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

Accordingly, an aspect of the disclosure is to provide a method of signal and channel structures for low-end IoT devices such as AIoT devices.

An aspect of the disclosure is to provide a method enabling communicating nodes to flexibly transmit one or more payload signals/channels in one transmission, and to flexibly transmit the payload signals/channels to the same or different nodes in one transmission based on the indication of the identity, for UL and DL communication by the AIoT device.

An aspect of the disclosure is to provide a flexible signal/channel design which adapts to different application scenarios and reduces resource waste and excessive time delay of transmitting multiple payload signals/channels over an air interface.

An aspect of the disclosure is to provide a method enabling a signal or channel to include one or more payloads and allowing the payloads to correspond to the same or different receiving nodes, thereby enhancing the flexibility of the communication system, reducing overhead and time delay of transmitting multiple payloads through multiple signals/channels, and more efficiently operating the system.

In accordance with an aspect of the disclosure, a method executed by a user equipment (UE) in an AIoT (Ambient Internet of Things) system includes receiving at least one payload header in a DL signal, wherein the at least one payload header includes information related to an identity of the UE, and receiving at least one payload corresponding to the at least one payload header in the DL signal based on the information related to the identity of the UE.

In an embodiment, the information related to the identity of the UE includes at least one of: information related to an identity of one UE; information related to an identity of a UE group or a UE set; and information related to a UE identity corresponding to all UEs.

In an embodiment, the at least one payload header corresponds to the at least one payload one by one, or each of the at least one payload header corresponds to one or more of the at least one payload.

In an embodiment, the downlink signal includes a payload total header including at least one of: information related to an identity of at least one UE that receives the downlink signal; information related to an identity of a node that transmits the downlink signal; information related to a number of the at least one payload header; information related to a number of the at least one payload; information related to a length of one or more of the at least one payload header; information related to a type of one or more of the at least one payload header; information related to a total length of the downlink signal; information related to a total length of the payload total header and the at least one payload header; information related to a total length of the at least one payload header; and information related to a total length of the at least one payload.

In an embodiment, the payload total header is transmitted at a start position of the downlink signal, and/or transmitted before the at least one payload header and the at least one payload.

In an embodiment, the downlink signal includes a first indicator that indicates a start position of a payload header. The first indicator is transmitted at least one of: a start position of one or more or each of the at least one payload header; a start position of a first payload header of the at least one payload header; and a start position of the payload total header.

In an embodiment, the downlink signal includes a second indicator that indicates an end position of a payload header. The second indicator is transmitted at least one of: an end position of one or more or each of the at least one payload header; an end position of a last payload header of the at least one payload header; and an end position of the payload total header.

In an embodiment, the downlink signal includes a third indicator that indicates a start position of a payload. The third indicator is transmitted at least one of: a start position of one or more or each of the at least one payload; and a start position of a first payload of the at least one payload.

In an embodiment, the downlink signal includes a fourth indicator that indicates an end position of a payload. The fourth indicator is transmitted at least one of: an end position of one or more or each of the at least one payload; and an end position of a last payload of the at least one payload.

In an embodiment, the downlink signal includes a synchronization signal that is transmitted at least one of: a start position of the downlink signal; a position in a middle of any payload header in the downlink signal; a position in a middle of any payload in the downlink signal; and a position between any payload header in the downlink signal and a corresponding payload.

In an embodiment, a portion of the downlink signal before the synchronization signal ends with a fifth indicator, and/or a portion of the downlink signal after the synchronization signal starts with a sixth indicator.

In an embodiment, the payload total header and/or the at least one payload header and/or the at least one payload in the downlink signal is transmitted in a repetitive and continuous mode.

In an embodiment, the transmission includes at least one of: the payload total header being repeatedly and continuously transmitted, each of the at least one payload header being repeatedly and continuously transmitted, and each of the at least one payload being repeatedly and continuously transmitted; the payload total header being repeatedly and continuously transmitted, and a combination of each of the at least one payload header and a corresponding payload being repeatedly and continuously transmitted; and a combination of the payload total header, the at least one payload header and the at least one payload being repeatedly and continuously transmitted.

In an embodiment, the at least one payload header indicates that an information bit after the at least one payload header correspond to another payload header or a corresponding payload.

In an embodiment, the payload total header indicates information related to identities of all receiving nodes corresponding to the downlink signal, and the at least one payload header indicates information related to an identity of a receiving node corresponding to a payload corresponding to the at least one payload header.

In accordance with an aspect of the disclosure, a method performed by a UE in a AIoT (Ambient Internet of Things) system includes determining at least one payload header in an UL signal, wherein the at least one payload header includes information related to an identity of an intermediate node and/or a BS, and transmitting the UL signal based on the information related to the identity of the intermediate node and/or the BS, wherein the UL signal includes the at least one payload header and at least one payload corresponding to the at least one payload header.

In an embodiment, the information related to the identity of the intermediate node and/or the base station includes at least one of: information related to an identity of one intermediate node and/or one base station; information related to an identify of an intermediate node group and/or a base station group or an intermediate node set and/or a base station set; and information related to an identity of one intermediate node and/or one base station corresponding to all intermediate nodes and/or base stations.

In an embodiment, the uplink signal includes a payload total header including at least one of: information related to an identity of at least one UE that receives the uplink signal; information related to a number of the at least one payload header; information related to a length of each of the at least one payload header; information related to a type of each of the at least one payload header; information related to a total length of the uplink signal; information related to a total length of the payload total header and the at least one payload header; information related to a total length of the at least one payload header; and information related to a total length of the at least one payload.

In an embodiment, the payload total header is transmitted at a start position of the uplink signal, and/or transmitted before the at least one payload header and the at least one payload.

In accordance with an aspect of the disclosure, a method performed by a first node in an AIoT (Ambient Internet of Things) system includes receiving at least one payload header in an UL signal, wherein the at least one payload header includes information related to an identity of an intermediate node and/or a BS, and receiving at least one payload corresponding to the at least one payload header in the UL signal based on the information related to the identity of the intermediate node and/or the BS.

In accordance with an aspect of the disclosure, a method performed by a first node in an AIoT (Ambient Internet of Things) system including: determining at least one payload header in a DL signal, wherein the at least one payload header includes information related to an identity of a UE (UE), and transmitting the DL signal based on the information related to the identity of the UE, wherein the DL signal includes the at least one payload header and at least one payload corresponding to the at least one payload header.

In accordance with an aspect of the disclosure, a UE in an AIoT (Ambient Internet of Things) system including: memory storing one or more instructions, and at least one processor configured to execute the one or more instructions stored in the memory to perform the aforementioned methods.

In accordance with an aspect of the disclosure, a node in an AIoT (Ambient Internet of Things) system including: memory storing one or more instructions, and at least one processor configured to execute the one or more instructions stored in the memory to perform the aforementioned methods.

### BRIEF DESCRIPTION OF DRAWINGS

The above and other aspects, features, and advantages of certain embodiments will be more apparent from the following description taken in conjunction with the accompanying drawings, in which:

FIG. 1 illustrates a wireless network according to an embodiment;

FIG. 2A illustrates a wireless transmission path according to an embodiment;

FIG. 2B illustrates a wireless reception path according to an embodiment;

FIG. 3A illustrates a UE according to an embodiment;

FIG. 3B illustrates a gNB according to an embodiment;

FIG. 4 illustrates a method performed by a UE according to an embodiment;

FIG. 5 illustrates a method performed by a UE according to an embodiment;

FIG. 6 illustrates a method performed by a node according to an embodiment;

FIG. 7 illustrates a method performed by a node according to an embodiment;

FIG. 8A illustrates a signal structure including a payload header and a payload according to an embodiment;

FIG. 8B illustrates a signal structure including multiple payload headers and multiple payloads according to an embodiment;

FIG. 8C illustrates a signal structure including multiple payload headers and multiple payloads according to an embodiment;

FIG. 8D illustrates an SS transmitted in a signal according to an embodiment;

FIG. 8E illustrates an SS transmitted within a payload according to an embodiment;

FIG. 9A illustrates an SS and a payload channel transmitted in a repetitive mode according to an embodiment;

FIG. 9B illustrates an SS and a payload channel transmitted in a repetitive mode according to an embodiment;

FIG. 10 illustrates a UE according to an embodiment; and

FIG. 11 illustrates a node according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Terms indicating a network entity or a network function and entities of an edge computing system, and terms indicating messages and identification information used in the disclosure are provided for convenience of description. Accordingly, the disclosure is not limited to the terms described below, and other terms indicating an object having an equivalent technical meaning may be used.

Herein, the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used herein includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

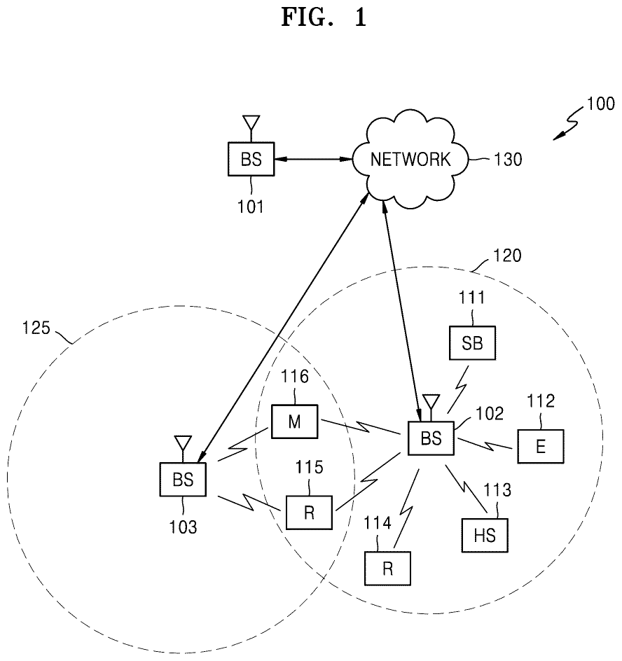

FIG. 1 illustrates a wireless network 100 according to an embodiment. The embodiment of the wireless network 100 shown in FIG. 1 is for illustration only. Other embodiments of the wireless network 100 can be used without departing from the scope of the present disclosure.

Referring to FIG. 1, the wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms such as BS or access point can be used instead of gNodeB or gNB. For convenience, the terms gNodeB and gNB are used in this patent document to refer to network infrastructure components that provide wireless access for remote terminals. And, depending on the type of the network, other well-known terms such as mobile station, user station, remote terminal, wireless terminal or user apparatus can be used instead of UE or UE. For convenience, UE as used herein refers to a remote wireless device that wirelessly accesses the gNB, whether the UE is a mobile device (such as a mobile phone or a smart phone) or a fixed device (such as a desktop computer or a vending machine).

The gNB 102 provides wireless broadband access to the network 130 for a first plurality of UEs within a coverage area 120 of gNB 102. The first plurality of UEs includes UE 111, which may be located in a small business (SB), UE 112, which may be located in an enterprise (E), UE 113, which may be located in a wireless fidelity (WiFi) hotspot (HS), UE 114, which may be located in a first residence (R), UE 115, which may be located in a second R, UE 116, which may be a mobile device (M), such as a cellular phone, a wireless laptop computer, a wireless personal data assistant (PDA), etc. The gNB 103 provides wireless broadband access to network 130 for a second plurality of UEs within a coverage area 125 of gNB 103. The second plurality of UEs includes UE 115 and UE 116. Alternatively, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

One or more of gNB 101, gNB 102, and gNB 103 include a two-dimensional (2D) antenna array or may support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, or the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

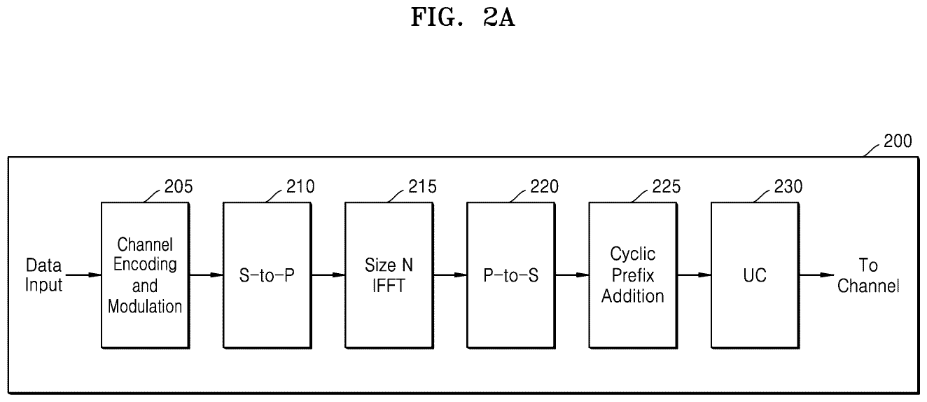

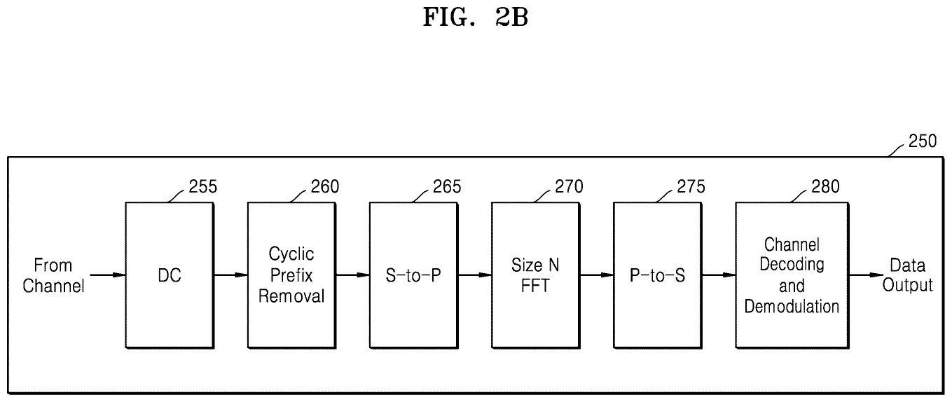

FIG. 2A illustrates a wireless transmission path according to an embodiment. FIG. 2B illustrates a wireless reception path according to an embodiment. The transmission path 200 can be implemented in a gNB, such as gNB 102, and the reception path 250 can be implemented in a UE, such as UE 116. However, the reception path 250 can be implemented in a gNB and the transmission path 200 can be implemented in a UE. Alternatively, the reception path 250 is configured to support codebook designs and structures for systems with 2D antenna arrays as described herein.

Referring to FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix (CP) addition block 225, and an up-converter (UC) 230. Referring to FIG. 2B, the reception path 250 includes a down-converter (DC) 255, a CP removal block 260, an S-to-P block 265, a size N FFT block 270, a P-to-S block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The S-to-P block 210 demultiplexes serial modulated symbols into parallel data to generate N parallel symbol streams, where N is a size of the IFFT/FFT used in the gNB 102 and UE 116. The size N IFFT block 215 performs IFFT operations on the N parallel symbol streams to generate a time-domain output signal. The P-to-S block 220 multiplexes parallel time-domain output symbols from the Size N IFFT block 215 to generate a serial time-domain signal. The CP addition block 225 inserts a CP into the time-domain signal. The up-converter 230 up-converts the output of the CP addition block 225 to an RF frequency for transmission via a wireless channel. The signal can also be filtered at a baseband before switching to RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the CP removal block 260 removes the CP to generate a serial time-domain baseband signal. The S-to-P block 265 converts the time-domain baseband signal into a parallel time-domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the DL and may implement a reception path 250 similar to that for receiving from UEs 111-116 in the UL. Similarly, each of UEs 111-116 may implement a transmission path 200 for transmitting to gNBs 101-103 in the UL and may implement a reception path 250 for receiving from gNBs 101-103 in the DL.

Each of the components in FIGS. 2A and 2B can be implemented using only hardware or using a combination of hardware and software/firmware. For example, at least some of the components in FIGS. 2A and 2B may be implemented in software, while other components may be implemented in configurable hardware or a combination of software and configurable hardware. The FFT block 270 and IFFT block 215 may be implemented as configurable software algorithms, in which the value of the size N may be modified according to the implementation.

Although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. For DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B are intended to illustrate examples of types of transmission and reception paths that can be used in a wireless network. Any other suitable architecture can be used to support wireless communication in a wireless network.

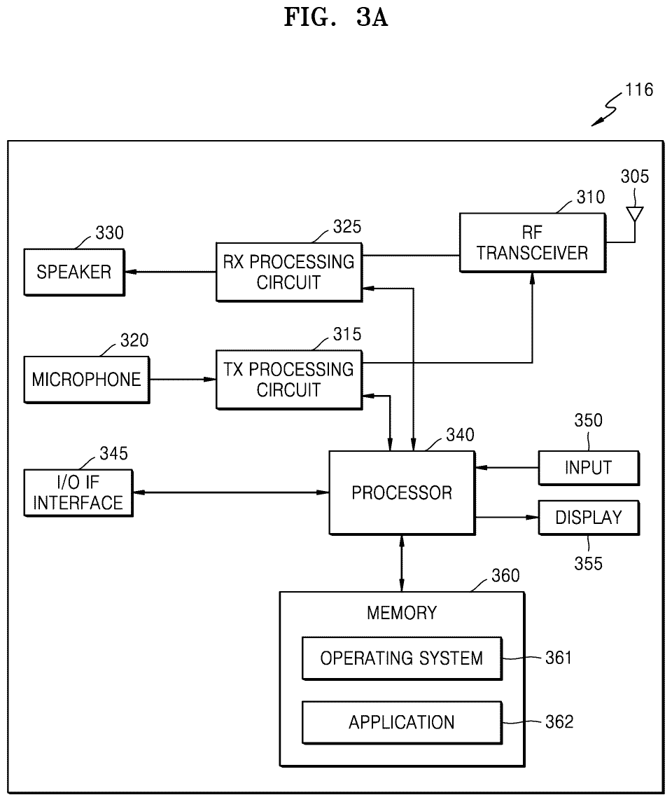

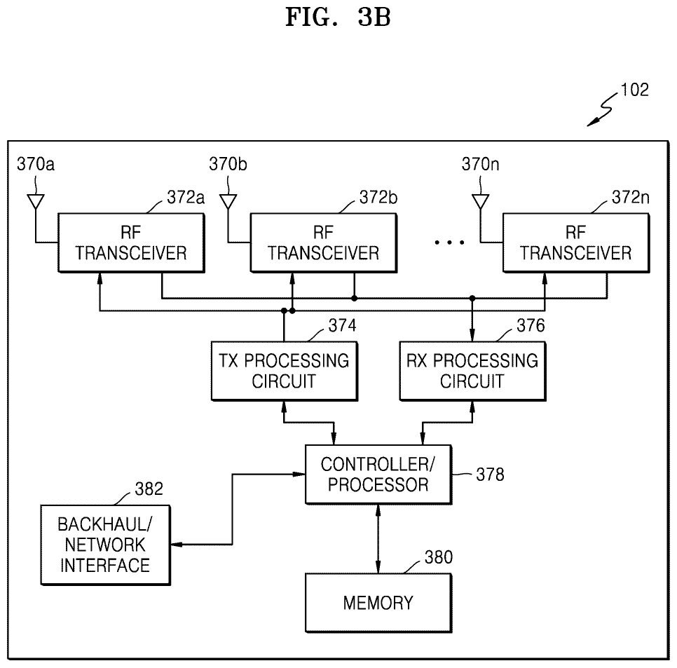

FIG. 3A illustrates a UE 116 according to an embodiment. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

Referring to FIG. 3A, the UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305 and down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and executes an OS 361 stored in the memory 360 to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. Alternatively, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described herein. The processor/controller 340 can move data into or out of the memory 360 as required by an execution process. Alternatively, the processor/controller 340 is configured to execute the application 362 based on the OS 361 or in response to signals received from the gNB or the operator. The processor/controller 340 is also coupled to an I/O interface 345 which provides the UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. For example, the processor/controller 340 can be divided into a plurality of processors, such as one or more central processing units (CPUs) and one or more graphics processing units (GPUs). Although FIG. 3A illustrates that the UE 116 is configured as a mobile phone or a smart phone, UEs can be configured to operate as other types of mobile or fixed devices.

FIG. 3B illustrates a gNB 102 according to an embodiment. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a TX processing circuit 374, and an RX processing circuit 376. One or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378 and encodes, multiplexes and/or digitizes outgoing baseband data to generate a processed baseband or IF signal. The RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102. Alternatively, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described herein. Alternatively, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 enables the gNB 102 to communicate with other gNBs through wired or wireless backhaul connections. When gNB 102 is implemented as an access point, the backhaul or network interface 382 enables the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. A plurality of instructions, such as the BIS algorithm, is stored in the memory and is configured to cause the controller/processor 378 to execute the BIS process and decode the received signal after subtracting at least one interference signal determined by the BIS algorithm.

The transmission and reception paths of gNB 102 (implemented using RF transceivers 372a-372n, TX processing circuit 374 and/or RX processing circuit 376) support aggregated communication with frequency division duplex (FDD) cells and time division duplex (TDD) cells.

Although FIG. 3B illustrates an example of gNB 102, various changes may be made to FIG. 3B. For example, gNB 102 can include any number of each component shown in FIG. 3A. The access point can include many backhaul or network interfaces 382, and the controller/processor 378 can support routing functions to route data between different network addresses. Although shown as including a single instance of the TX processing circuit 374 and a single instance of the RX processing circuit 376, gNB 102 can include multiple instances of each (such as one for each RF transceiver).

In order to make the purpose, technical schemes and advantages of the present application clearer, the implementations of the present application will be further described in detail with reference to the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In the Long Term Evolution (LTE) technology, the Internet of Things (IoT) technology includes Machine Type Communication (MTC) and Narrowband Internet of Things (NB-IoT). These two kinds of communication technologies have the characteristics of low cost, low power consumption, high delay, wide coverage, large-scale access and so on, and can be used in Internet of Things scenarios such as smart cities, smart factories and remote meter reading.

The Internet of Things technology has the characteristics of low cost, low power consumption, supporting large-scale connection and so on, and is usually used in smart factories, smart medical care, urban management and other application scenarios with a large number of devices and emphasis on cost control to achieve the communication effect of the Internet of Everything.

IoT devices receive downlink signals and transmit uplink signals in different ways from traditional wireless communication. Ambient IoT (AIoT) devices are a kind of low-end IoT devices with low cost and low power consumption. In the application, because the transmission of such IoT devices mainly depends on ambient signals, they are called Ambient IoT devices, which are named mainly for convenience of description and are not used to limit the scope of devices.

The methods of receiving downlink signals and transmitting uplink signals of Ambient IoT devices are different from those of traditional wireless communication, so it is impossible to correctly receive the synchronization signals in cell communication and perform system synchronization based on the synchronization signals in cell communication. Therefore, an enhanced transmission method of synchronization signals is needed, which can be used for synchronization of AIoT devices.

The invention provides a design method of signal and channel structures for low-end Internet of Things devices such as Ambient IoT devices. The method enables the communicating nodes to flexibly transmit one or more payload signals/channels in one transmission, and enables the communicating nodes to flexibly transmit the payload signals/channels to the same or different nodes in one transmission based on the indication of the identity; therefore, the Ambient IoT device can use this structure for uplink and downlink communication, and the signal/channel design is more flexible, adapting to different application scenarios, and reducing the resource waste and extra time delay of transmitting multiple payload signals/channels over the air interface.

In an AIoT system, the transmission of signals/channels such as data and services can be directly transmitted between a base station and an AIoT node (such as a tag device); it can also be transmitted via an intermediate node, for example, the base station transmits information related to the AIoT system to the intermediate node, and the intermediate node transmits data to the AIoT node; and the AIoT node transmits the data to the intermediate node, and the intermediate node transmits the information related to the AIoT system to the base station.

In the specification, for the services in the AIoT system, with a similar principle to the traditional cell communication, the transmission transmitted by the base station or by the intermediate node to the AIoT node is called downlink transmission, and the transmission transmitted by the AIoT node to the base station or to the intermediate node is called uplink transmission. In addition, the transmission related to the AIoT system that is transmitted by the base station to the intermediate node can also be called downlink transmission, and the transmission related to the AIoT system that is transmitted by the intermediate node to the base station can be called uplink transmission. Unless otherwise specified in the specification, the uplink/downlink transmission corresponds to the relationship between the transmitting and receiving nodes, and is not used to limit whether the transmission occurs on uplink or downlink resources. For example, the uplink transmission in the AIoT system can also be transmitted and received in the downlink spectrum in an FDD system, and the downlink transmission in the AIoT system can also be transmitted and received in the uplink slot in a TDD system.

The base station in the specification can also be replaced by other devices, such as communication devices as plug-in attachments of the base station, relay nodes, IAB nodes, repeater nodes and sidelink nodes. Any mechanism applicable to the base station in the specification can also be similarly used in the scenario where the base station is replaced by other nodes, and the description are not redundantly repeated. The difference between the communication devices of plug-in attachments of the base station and the base station may include: the devices can transmit DL signals/channels on the UL spectrum in the FDD system and on the UL time unit in the TDD system, including transmitting DL signals/channels corresponding to the communication between the base station and the UE and the communication between the base station and the AIoT device.

The intermediate node in the specification may be at least one of a relay node, an IAB node, a repeater node, and a sidelink node.

The UE in the specification includes a device node in the AIoT system, which can be a specific type of node or device, such as a tag type of device.

In the embodiment of the present application, below a threshold can also be replaced by below or equal to the threshold, above (exceeding) the threshold can also be replaced by above or equal to the threshold, less than or equal to can also be replaced by less than, greater than or equal to can also be replaced by greater than; and vice versa.

In the embodiment of the present application, unless otherwise specified, configuration information includes at least one of information configured by the base station, indicated in the received signaling, configured by the higher layer and preconfigured. Further, it can be a set of configuration information obtained by the above methods; it can also be multiple sets of configuration information obtained by the above method, and the UE or node can select a set of configuration information to use according to predefined conditions; it can also be a set of configuration information obtained by the above method, and the set of configuration information includes multiple subsets, and the UE or node can select a subset to use according to predefined conditions.

The AIoT device cannot be deployed and operated in traditional cell communication, because of its simple structure and different basic communication principles from traditional wireless communication methods, so it is necessary to design another communication system for it. The specification provides a design method of signal and channel structure in communication system, which can make a signal or channel include one or more payloads, and make the multiple payloads in the signal or channel correspond to the same or different receiving nodes, thus enhancing the flexibility of the communication system, reducing the extra overhead and time delay of transmitting multiple payloads through multiple signals/channels, and making the system run more efficiently.

Herein, a signal structure includes a structure of a UL signal and/or channel, and/or a structure of a DL signal and/or channel, unless otherwise limited.

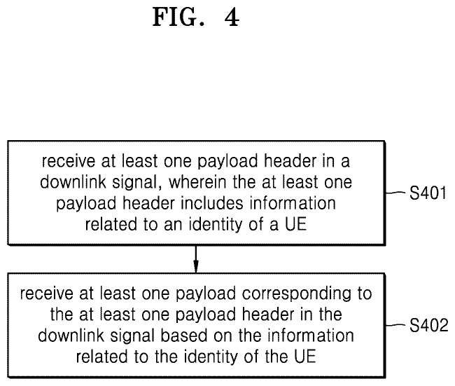

FIG. 4 illustrates a method performed by a UE according to an embodiment. Referring to FIG. 4, in step S401, at least one payload header in a DL signal is received, wherein the at least one payload header includes information related to an identity of the UE. In step S402, at least one payload corresponding to the at least one payload header in the DL signal is received based on the information related to the identity of the UE.

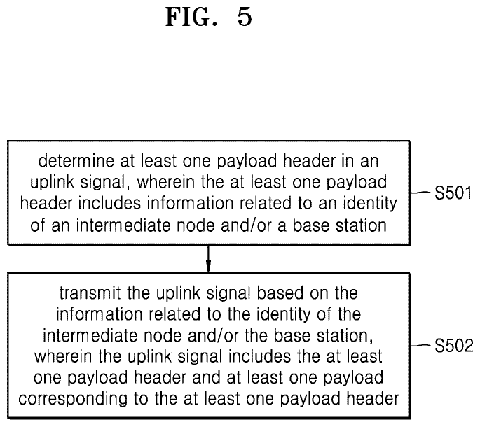

FIG. 5 illustrates a method performed by a UE according to an embodiment. Referring to FIG. 5, in step S501, at least one payload header in an UL signal is determined, wherein the at least one payload header includes information related to an identity of an intermediate node and/or a BS. In step S502, the UL signal is transmitted based on the information related to the identity of the intermediate node and/or the BS, wherein the UL signal includes the at least one payload header and at least one payload corresponding to the at least one payload header.

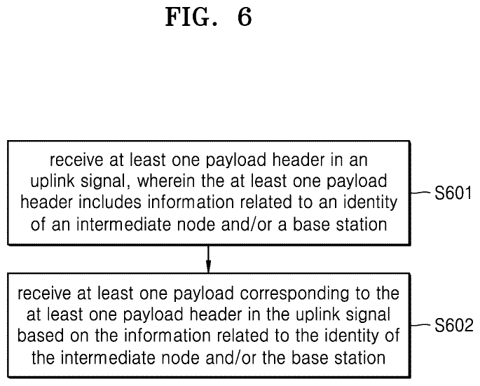

FIG. 6 illustrates a method performed by a node according to an embodiment. Referring to FIG. 6, in step S601, at least one payload header in an UL signal is received, wherein the at least one payload header includes information related to an identity of an intermediate node and/or a BS. In step S602, at least one payload corresponding to the at least one payload header included in the UL signal is received based on the information related to the identity of the intermediate node and/or the BS.

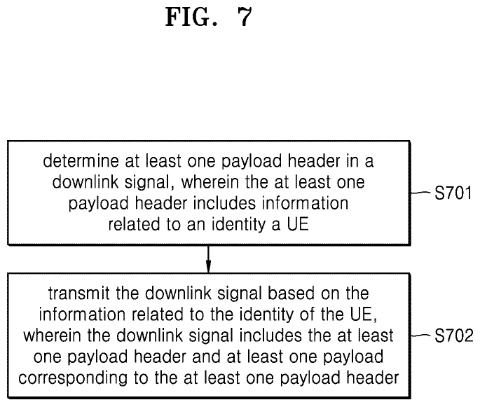

FIG. 7 illustrates a method performed by a node according to an embodiment. Referring to FIG. 7, in step S701, at least one payload header in a DL signal is determined, wherein the payload header includes information related to an identity of a UE. In step S702, the DL signal is transmitted based on the identity of the UE, wherein the DL signal includes the at least one payload header and at least one payload corresponding to the at least one payload header.

Optionally, the identity of the UE includes at least one of: an identity of one UE, an identity of a UE group or a UE set, and a UE identity corresponding to all UEs (i.e. corresponding to broadcast).

Optionally, in a wireless communication system, a signal structure includes at least one payload header; at least one payload. A payload header is used to indicate related information of a corresponding payload, for example, control information such as a type and length of the payload and an identity of a target UE.

Optionally, according to preset and/or (pre-)configured criteria, the at least one payload header corresponds to the at least one payload one by one. Optionally, according to preset and/or (pre-)configured criteria, each payload header corresponds to one or more payloads; further, each payload header corresponds to multiple payloads of the same type, for example, multiple payloads used for random access request response, multiple payloads used for indicating DL data, or multiple payloads used for indicating scheduling information for UL data.

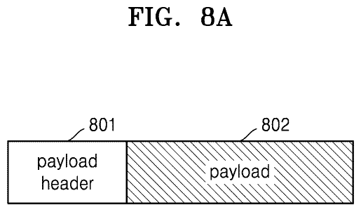

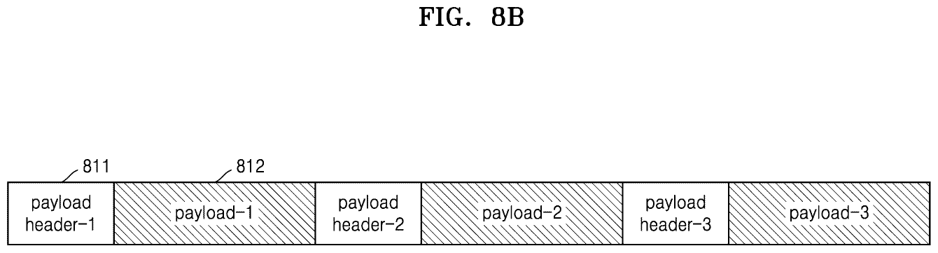

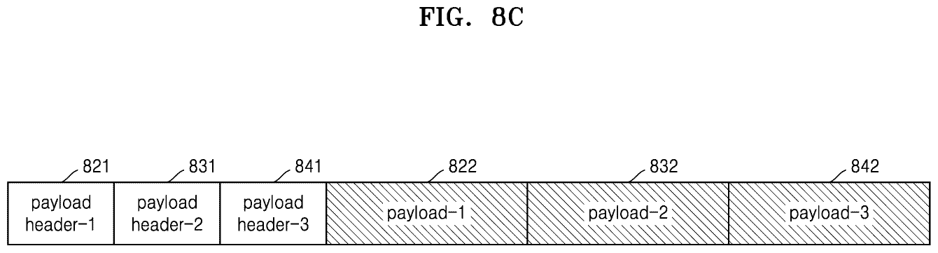

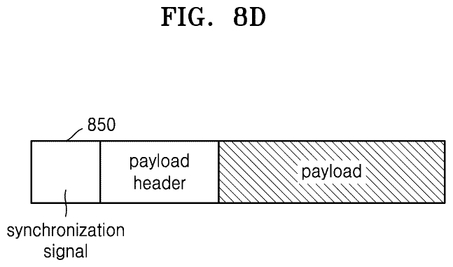

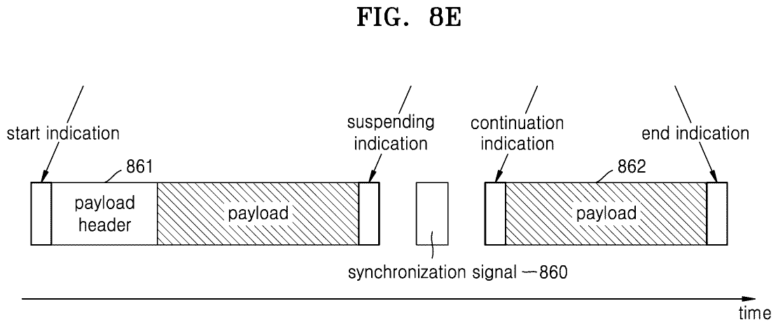

FIG. 8A illustrates a signal structure including a payload header and a payload according to an embodiment. Referring to FIG. 8A, the payload header 801 is located in front of (before) the payload 802.

FIG. 8B illustrates a signal structure including multiple payload headers and multiple payloads according to an embodiment. Referring to FIG. 8B, the payload header 1 (811) is located before the corresponding payload 1 (812) and is continuous with the corresponding payload; and a combination of the payload header and the corresponding payload is before or after another combination.

FIG. 8C illustrates a signal structure including multiple payload headers and multiple payloads according to an embodiment. Referring to FIG. 8C, payload header is located before the corresponding payload, and may be discontinuous with the corresponding payload; and all the payload headers 821, 831, 841 are before all the payloads 822, 832, 842.

In FIGS. 8B and 8C, the numbers after the payload headers and the payloads are used to identify the corresponding relationship.

Optionally, the signal structure also includes a payload total header for indicating at least one of an identity (ID) of a UE that receives the signal structure, a number of payload headers, a length of a payload header, a type of a payload header, a total length of the signal structure, a total length of the payload total header and all payload headers, a total length of all payload headers, and a total length of all payloads. Optionally, a position of the payload total header is at a start position of the signal structure, and/or before all payload headers and payloads. Optionally, the method is used when multiple payload headers are included in the signal structure. Optionally, when the signal structure includes a payload header and/or a payload, the payload header is replaced by the payload total header; and/or, when a payload is included in the signal structure, the signal structure includes a payload total header and does not include the payload header. The payload total header can also be called a preamble payload header. Optionally, there can also be a payload header before the first payload header, which can be called the payload total header.

Optionally, a signal format of at least one of the payload header and/or the payload total header herein is preset or (pre-)configured.

Optionally, the signal structure further includes a start position indicated by a start indicator, and an end position indicated by an end indicator.

Optionally, the signal structure further includes a payload header start indicator at a start position of at least one payload header, and/or at a start position of each payload header, and/or at a start position of all payload headers, and/or at a start position of the first payload header, and/or at a start position of the payload total header. At least one of the above payload headers/total headers may start with the payload header start indicator. The payload header start indicator at the start position of the payload total header and/or the start position of the first payload header may be the start indicator of the signal structure.

Optionally, the signal structure further includes a payload header end indicator at an end position of at least one payload header, and/or at an end position of each payload header, and/or at an end position of all payload headers, and/or at an end position of the last payload header, and/or at an end position of the payload total header. At least one of the above payload headers/total headers ends with the payload header end indicator. Optionally, if there is the payload header end indicator at the end position of the last payload header, the indicator is used as a boundary position between the payload header and the payload. Accordingly, at least one of the UE, the intermediate node and the BS determines the last payload header in the signal structure through the position of the payload header end indicator, and/or determines that the information after a payload is another payload or data.

Optionally, the signal structure further includes a payload start indicator at a start position of at least one payload, and/or at a start position of each payload, and/or at a start position of all payloads, and/or at a start position of the first payload. The at least one payload may start with the payload start indicator.

Optionally, the signal structure further includes a payload end indicator at an end position of at least one payload, and/or at an end position of each payload, and/or at an end position of all payloads, and/or at an end position of the last payload. The at least one payload ends with the payload end indicator. The payload end indicator at the end position of the last payload may be the end indicator of the signal structure.

For at least one of the above start indicator of the signal structure, end indicator of the signal structure, payload header start indicator, payload header end indicator, payload start indicator and payload end indicator, optionally, the indicator is a signal waveform with different signal structures from those of corresponding information bits “0” and “1”; For example, the signal structure corresponding to information bit “0” is a low voltage level with length x1 followed by a high voltage level with length x2, the signal structure corresponding to information bit “1” is a high voltage level with length x3, the start indicator is a low voltage level with length y1 followed by a high voltage level with length y2, and the end indicator is a low voltage level with length y3 followed by a high voltage level with length y4, and x1 is not equal to y1 and/or x2 is not equal to y2, and x1 is not equal to y4.

Different indicators among the above indicators may correspond to the same or different signal waveforms. For example, y1 is not equal to y3 and/or y2 is not equal to y4. Alternatively, the indicator can also be a preset specific field, such as “000” and “111”; and different indicators among the above indicators may correspond to the same or different specific fields. The start and end indicators of the signal structure correspond to different signal waveforms, the start indicator of the payload header and the start indicator of the payload correspond to one sequence, and the end indicator of the payload header and the end indicator of the payload correspond to another sequence.

Optionally, the signal structure further includes a synchronization signal (SS) transmitted at the start position of the signal structure, wherein the SS is a part of the signal structure. Alternatively, the signal structure also includes an SS transmitted before the start position of the signal structure, wherein the SS does not belong to a part of the signal structure.

FIG. 8D illustrates an SS transmitted in a signal according to an embodiment. This method can be combined with other signal structure related methods.

Referring to FIG. 8D, the signal structure includes an SS 850 transmitted at the start position of the signal structure, but may be transmitted before or after the start indicator of the signal structure. Alternatively, when the signal structure includes an SS transmitted at or before the start position of the signal structure, the start position of the signal structure does not include a start indicator, and/or the SS can be used to determine the start position of the signal structure. In this manner, the SS performs as the start indicator of the signal structure in a physical sense; Accordingly, at least one of the UE, the intermediate node and the BS determines the start position of the signal structure and/or components in the signal structure according to the position of the SS. For example, the start position of the SS is the start position of the signal structure, and/or the start position of the synchronization signal is the start position of the first component in the signal structure, such as a payload header or a payload total header.

FIG. 8E illustrates an SS transmitted within a payload according to an embodiment. Referring to FIG. 8E, the signal structure includes an SS 860 transmitted in the middle of a payload header 861, and/or in the middle of a payload 862, and/or between two payload headers, and/or between two payloads, and/or between the payload header 861 and the payload 862. Alternatively, the SS may be transmitted between the payload header and the payload. The payload header may or may not correspond to the payload, and may be an adjacent payload header and payload, such as between payload 1 and payload header 1 in FIG. 8B or between payload 1 and payload header 2. Another example is where the SS may be between the payload header 3 and the payload 1 in FIG. 8C or between two payload headers, for example, between payload header-1 and payload header-2 in FIG. 8C. In another example of the synchronization signal, the synchronization signal is transmitted between two payloads, for example, between payload-2 and payload-3 in FIG. 8c. Although the payload and the payload header, or the payload and the payload, or the payload header and the payload header are not physically adjacent after the SS is inserted, they are referred to as adjacent payload headers and payloads from the point of view of the position between the payload header and the payload to describe the relationship between them. The adjacent payload headers and payloads can also be described as a payload before or after any payload header, that is, the SS is transmitted between any payload header and a payload before or after the payload header.

This method can be used in combination with other signal structure related methods, for example, before the start indicator identified in the figure, at the start position of the channel structure, an SS can also be included, or an SS can be included before the start position of the signal structure.

Alternatively, when the signal structure includes an SS transmitted in the middle of a payload, and/or in the middle of a payload, and/or between the payload and the payload, the part of the signal structure before the SS ends with a suspending indicator, and/or the part after the SS starts with a continuation indicator.

Optionally, the continuation indicator has the same signal structure as at least one of the start indicator, the payload header start indicator and the payload start indicator of the signal structure; further, the continuation indicator has the same signal structure as the payload start indicator when the SS is transmitted in the middle of the payload, and/or the continuation indicator has the same signal structure as the payload start indicator when the SS is transmitted in the middle of the payload and/or between the payload and the payload. Optionally, the suspending indicator has the same signal structure as at least one of the end indicator of the signal structure, the end indicator of the payload header and the end indicator of the payload. The suspending indicator has the same signal structure as the payload header end indicator when the SS is transmitted in the middle of the payload header and/or between the payload header and the payload, and/or the continuation indicator has the same signal structure as the payload end indicator when the SS is transmitted in the middle of the payload. This method simplifies the design of channel detection and reduces system complexity. Alternatively, the continuation indicator and/or the suspending indicator has different signal structures from various types of start and/or end indicators, so that the BS, the intermediate node and the UE can accurately identify whether the signal/channel really ends or is temporarily stopped due to the SS, so as to better detect the SS based on the indicator and to more easily resume the continuous reception of the signal/channel after detecting the SS instead of treating the subsequent signal/channel as a new transmission.

Optionally, when repetition is enabled in the system, and/or when repetition is used for at least one signal and/or channel in the system, the at least one signal and/or channel is transmitted in the repetitive form, including at least one of:
each payload total header/payload header/payload in the signal structure is transmitted in a repetitive and continuous mode, for example, the payload total header is repeated for the first time, the payload total header is repeated for the second time, . . . the payload total header is repeated for the N-th time, the first payload header is repeated for the first time, the first payload header is repeated for the second time, . . . the last payload header is repeated for the N-th time, the first payload is repeated for the first time, the first payload is repeated for the second time, . . . the last payload is repeated for the first time, . . . the last payload is repeated for the N-th time.

As such, each component in the signal structure is transmitted continuously, which is easy to be combined.

Each payload header and payload in the signal is a combination, and each combination is transmitted in a repetitive and continuous mode. For example, the payload total header is repeated for the first time, the payload total header is repeated for the second time, . . . the payload total header is repeated for the N-th time, the first payload header is repeated for the first time, the first payload header is repeated for the second time, . . . the first payload header is repeated for the N-th time, the first payload is repeated for the first time, the first payload is repeated for the second time, . . . the first payload is repeated for the first time, the second payload header is repeated for the first time, the second payload header is repeated for the second time, . . . the second payload header is repeated for the N-th time, the second payload is repeated for the first time, the second payload is repeated for the second time, . . . .

As such, the payload header itself mainly transmits control information and is used for receiving the payload, so a group of signals carrying data/service information are repeatedly transmitted by the payload header and the payload, and the part which is received first in the receiving process can be directly used to reduce a time delay;
repetition in the unit of channel structure, for example, the payload total header is repeated for the first time, the first payload header is repeated for the first time, the second payload header is repeated for the first time, the last payload is repeated for the first time, the payload total header is repeated for the second time, . . . the first payload header is repeated for the second time, . . . .

As such, the different repetitions of the same payload/payload are far apart, so that fading and interference in the time domain can be averaged relatively well, which prevents multiple repetitions of the same payload/payload from all being influenced by the same deep fading or the same interference signal and from being undecodable.

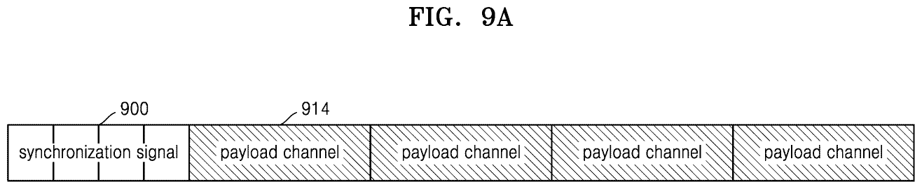

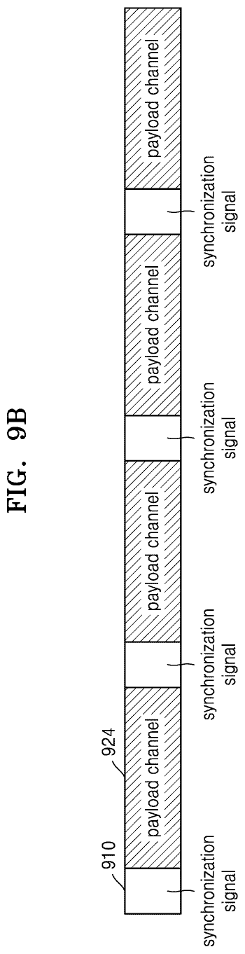

FIG. 9A illustrates an SS and a payload channel transmitted in a repetitive mode according to an embodiment. FIG. 9B illustrates an SS and a payload channel transmitted in a repetitive mode according to an embodiment. If the signal structure further includes an SS transmitted at the start position of the signal structure and/or an SS transmitted before the start position of the signal structure, when repetition is enabled in the system, and/or when repetition is used in at least one signal and/or channel in the system, the at least one signal and/or channel is transmitted in the repetitive form, including at least one of:

Referring to FIG. 9A, the SS 900 is transmitted in the repetitive form, and/or payload channels 914 are transmitted in the repetitive form, and there are no payload channels and/or other synchronization signals between repeated synchronization signals.

Referring to FIG. 9B, the SS 910 is transmitted in the repetitive forms, and there are payload channels 924 corresponding to the SS between the repeated synchronization signals, further, at least one repetition of the payload channels corresponding to the SSs is included. When repeated synchronization signals include multiple repetitions of the corresponding payload channel, the repetition of the payload channel can use the methods in other embodiments described above.

Optionally, if the signal structure further includes an SS transmitted in the middle of the payload, and/or in the middle of the payload, and/or between the payload and the payload, when repetition is enabled in the system, and/or when repetition is used in at least one signal and/or channel in the system, the at least one signal and/or channel is transmitted in the repetitive form, including at least one of:
the start position of the at least one signal and/or channel as a reference point or at least one synchronization signal transmitted in the at least one signal and/or channel as a reference point, after the reference point, when the time for continuous transmission of the at least one signal and/or channel and/or the number of information bits exceed a threshold, transmitting an SS;
if the SS is located in the middle of the payload header and/or payload, when the payload header and/or payload are repeatedly transmitted, also transmitting the SS in the middle of the repeatedly transmitted payload header and/or payload;
if the SS is located between the payload header and the payload, when the payload header and/or payload before the SS is repeatedly transmitted, also transmitting the SS after the end position of the repeatedly transmitted payload header and/or payload; and/or when the payload header and/or payload after the SS are repeatedly transmitted, also transmitting the SS before the start position of the repeatedly transmitted payload header and/or payload.

Optionally, when repetition is enabled in the system, and/or when at least one signal and/or channel in the system uses repetition, the node transmitting the at least one signal and/or channel, and/or the node scheduling other nodes to transmit the at least one signal and/or channel, and/or the node receiving the at least one signal and/or channel needs to indicate repetition related information and transmit the at least one signal and/or according to the information, and/or acquiring the repetition related information and receiving the at least one signal and/or channel according to the information. Optionally, it includes indicating and transmitting and/or acquiring and receiving by at least one of:
indicating by at least one of an indicator and a signal preamble. The indicator includes at least one of a starting indicator of a signal structure, an ending indicator of a signal structure, a payload header starting indicator, a payload header ending indicator, a payload starting indicator and a payload ending indicator. The signal preamble includes at least one of the following synchronization signals, or at least one of the following synchronization signals and at least one of the above indicators (further, it is at least one of the above indicators corresponding to the starting): an SS transmitted at the starting position of the signal structure, an SS transmitted in the middle of the payload header, an SS transmitted in the middle of the payload, an SS transmitted between two payload headers, an SS transmitted between two payloads, and an SS transmitted between the payload header and the payload;
indicating by control information. Optionally, the method is used when the data corresponding to the control information uses repetition, or when the data corresponding to the control information uses repetition and the control information does not use repetition;
indicating by the payload header and/or the payload total header. Optionally, this method is used when the payload corresponding to the payload header and/or the payload total header uses repetition, or when the payload corresponding to the payload header and/or the payload total header uses repetition and the payload header and/or the payload total header does not use repetition.

The repetition related information includes at least one of the number of repetitions and the type of repetitions. The type of repetition further includes at least one of repetition at bit level, repetition at linear coded code chip level, and repetition at TB level. For example, the repetition at bit level includes repeating the first bit several times, then repeating the second bit for several times, and so on. The repetition at code chip level includes, after information bits (which can be original information bits, original information bits coded by forward error correction code FEC, information bits after repetition at bit/TB level, etc.) are linearly coded, a codeword corresponding to each information bit includes N code chips, the first code chip is repeated for several times, then the second code chip is repeated for several times, and so on. The codeword corresponding to the first information bit is repeated at the code chip level, and then the codeword corresponding to the second information bit is repeated at the code chip level, and so on.

Optionally, the method further includes indicating the number of repetitions of at least one signal and/or channel through the number of repetitions of at least one of the indicator and the signal preamble. For example, when the indicator is transmitted with repetition and the number of repetitions is n1, the at least one signal and/or channel is repeated with a number of repetitions n2, and there is a preset and/or configured mapping relationship between n1 and n2. For example, n2=n1+offset, where the value of offset is configured/preset. Alternatively, a node is preset/configured with a corresponding relationship between a set of n1 values and a set of n2 values, and the number of repetitions is indicated according to the preset/configuration. The method can also be further extended to indicate the number of repetitions of data and/or payload headers and/or payloads through the number of repetitions of at least one of control information, payload total header and payload header, and the specific method is similar to that through indicators and/or signal preambles.

Optionally, the method further includes indicating the repetition type of at least one signal and/or channel through the repetition type of at least one of the indicator and the signal preamble. For example, if the repetition type of the signal preamble is bit level, then the repetition type of the at least one signal and/or channel is bit level. Alternatively, if the repetition type of the signal preamble is bit level, then the repetition type of the at least one signal and/or channel is bit level or code chip level, and one of the bit level or code chip level can be further indicated by at least one of control information, payload total header and payload header. The method can also be further extended to indicate the repetition type of data and/or payload header and/or payload through the repetition type of at least one of control information, payload total header and payload header, and the specific method is similar to that through indicators and/or signal preambles.

Optionally, the method further includes indicating the repetition related information of the data and/or the payload header and/or the payload through a field for indicating the repetition related information in at least one of the control information, the payload total header and the payload header. Optionally, at least one of the control information, the payload total header and the payload header indicates repetition related information of data and/or the payload header and/or payload corresponding to the at least one of the control information, the payload total header and the payload header (for example, data corresponding to the control information, the payload header and/or the payload corresponding to the payload total header, the payload corresponding to the payload header), and/or indicating repetition related information of other data and/or payloads, and accordingly indicating information for identifying the data and/or payload header and/or payload, for example, the logical channel ID corresponding to the payload header/payload, the order of the payload header/payload in the signal structure (for example, the M-th payload header/payload), the resource location corresponding to the data (which can be indicated by the time-frequency offset of the resource where the control information is located), the payload header/payload/data transmitted before or after a given synchronization signal, the type of service corresponding to the payload header/payload/data (for example, inventory or command), and an ID of the receiving node corresponding to the payload header/payload/data. The given synchronization signal includes at least one of: an SS transmitted at the starting point of signal structure, an SS transmitted in the middle of a payload header, an SS transmitted in the middle of a payload, an SS transmitted between two payload headers, an SS transmitted between two payloads, and an SS transmitted between a payload header and a payload.

For the signal structure in the system, the nodes that transmit and receive the signal structure need to be able to determine which parts of the signal structure are payload headers and which parts are payloads. If there is only one payload header or one payload total header in the signal structure, since the formats used by the payload header and the payload total header can be preset and/or (pre-) configured (for example, configured in the broadcast channel), the node can parse the payload header/header through this format, and the remaining is the payload. If multiple payload headers and multiple payloads are allowed in the signal structure, the node cannot determine only according to the format, but also needs to know how many payload headers exist in the signal structure or which part of the channel structure the subsequent information after each payload header/payload ends belongs to.

Therefore, optionally, when the signal structure includes a payload total header, the number of payload headers and/or the number of payloads included in the signal structure is indicated in the payload total header. Optionally, this method is used when the signal structure can include one payload total header, multiple payload headers and multiple payloads, otherwise it is not used.

Optionally, when the signal structure includes at least one payload header and at least one payload, the information bit in at least one payload header indicating the end of the payload header corresponds to another payload header or a payload. For example, the payload header includes a 1-bit field whose two states are used to indicate that the subsequent signal is another payload header or payload, respectively. Optionally, this method is used when multiple payload headers and multiple payloads in the signal structure are allowed or configured in the system, otherwise it is not used. Optionally, this method is used when the payload header in the signal structure is located before the corresponding payload, and the corresponding payload can be discontinuous, and all the payload headers are before all the payloads, as shown in FIG. 8C, otherwise it is not used.

Optionally, when the signal structure includes at least one payload header and at least one payload, the ending position of the last payload header ends with the payload header ending indicator. The indicator is used to enable at least one of the UE, the intermediate node and the BS to distinguish whether all the payload headers have been completely transmitted and whether to start receiving the payload after the indicator. Optionally, this method is used when multiple payload headers and multiple payloads in the signal structure are allowed or configured in the system, otherwise it is not used. Optionally, this method is used when the payload header in the signal structure is located before the corresponding payload, and the corresponding payload can be discontinuous, and all the payload headers are before all the payloads, as shown in FIG. 8C, otherwise it is not used.

Optionally, when the signal structure includes at least one payload header and at least one payload, the ending position of at least one or each payload ends with a payload ending indicator. The indicator is used to enable at least one of the UE, the intermediate node and the BS to distinguish whether the current payload has been transmitted and whether to start receiving new payload headers and/or payloads after the indicator. Optionally, this method is used when multiple payload headers and multiple payloads in the signal structure are allowed or configured in the system, otherwise it is not used. Optionally, this method is used when the payload header in the signal structure is located before the corresponding payload and is continuous with the corresponding payload, and the combination of one payload header and the corresponding payload is before or after another combination, as in FIG. 8B, otherwise it is not used.

A signal structure can include multiple payloads corresponding to data or services with different usages respectively, for example, including a payload corresponding to an inventory and a payload corresponding to a command; for another example, the payload corresponding to different information data in the inventory, such as usage state, usage year, usage record, usage times and so on. The payload can be transmitted to the same or different nodes, such as transmitted by the UE to multiple intermediate nodes, and different payloads correspond to the reporting information corresponding to the inventory requests of different intermediate nodes, respectively.

A signal structure can also include multiple payloads corresponding to different UEs respectively. For example, in a random access procedure, multiple different UEs transmit random access requests respectively, and an intermediate node or a BS transmits random access response signaling. The signal structure used in the signaling includes multiple random access request responses, which respectively correspond to the random access requests of different UEs.

Therefore, a signal/channel transmitted in a node needs to indicate the corresponding receiving node in the used signal structure. A node receiving a signal/channel needs to determine whether to receive the signal/channel based on the information of the receiving node indicated in the used signal structure, and determine to receive which payloads in the signal structure used by the signal/channel.

Herein, the node includes at least one of a UE, an intermediate node and a BS, and the ID includes at least one of the ID of a node, the ID of a node group or node set, and the ID of a node corresponding to broadcast.

Optionally, the signal structure includes at least one payload header indicating the ID of the receiving node corresponding to its payload. When the signal structure includes multiple payload headers, each payload header can indicate the ID of the receiving node corresponding to its payload. That is, different payload headers can indicate different identities, and/or, one of the multiple payload headers can indicate the ID of the receiving node corresponding to all payloads, such that different payload headers correspond to the same receiving node. The one payload header may be the first one of multiple payload headers.

Optionally, when the signal structure includes a payload total header, the payload total header indicates the identities of all receiving nodes corresponding to the signal structure. The payload total header indicates that the payloads of the signal structure correspond to the same or different nodes, and the indication can be indicated by a specific field (e.g. 1 bit) or indirectly. For example, at least one specific ID (which can be all “0” or an ID corresponding to the broadcast) is preset and/or (pre-)configured to indicate that the payloads of the signal structure of the ID correspond to different nodes, and the rest identities are preset and/or (pre-)configured to indicate that the payloads of the signal structure of the ID corresponds to the same node. If the payloads correspond to the same node, there is no field indicating the ID of the receiving node corresponding to its payload in the payload header, or the node receiving the signal structure does not identify the field indicating the ID of the receiving node corresponding to its payload in the payload header. If the payloads correspond to different nodes, there is a field indicating the ID of the receiving node corresponding to its payload in the payload header, and the node receiving the signal structure also needs to identify the indication in the payload header to determine the receiving node corresponding to each payload respectively.

Optionally, when a groupcast ID is indicated in the payload total header included in the signal structure, the ID indicated in the payload header may be the ID of the UE in the group corresponding to the groupcast ID. Thus, the length of the ID in the group is usually short compared with a normal ID, which reduces signaling overhead.

Optionally, when the signal structure includes a payload total header, the payload total header indicates the ID of the node transmitting the signal structure. Optionally, the payload header included in the signal structure indicates the ID of the node transmitting the signal structure when the signal structure includes multiple payload headers. Alternatively, one of the payload headers indicates the ID of the node transmitting the signal structure, such as the first payload header, thus saving the overhead of multiple indications.

Optionally, after the node receiving the signal/channel identifies the ID corresponding to the signal structure and/or payload according to at least one of the above methods, the node determines whether it is necessary to receive the corresponding signal structure and/or payload according to determine whether the ID is consistent.

To improve the efficiency and capacity of the system, multiple access technology is considered in the AIoT system, so that multiple UEs can initiate random access requests in a random access procedure, and an intermediate node or a BS can respond to multiple UEs. This concerns when a signal/channel uses a signal structure transmitted to multiple nodes. The design of signal structure in this procedure will be described with specific examples.

Optionally, the random access procedure includes:
the intermediate node or the BS transmits a signaling for triggering the random access procedure;
the UE receives the signaling, is triggered to start the random access procedure and transmit a random access request on the resource used for the random access request;
the intermediate node or the BS transmits a random access request response to at least one UE based on the received random access request;
the UE receives the random access request response, and if the response is a response to the random access request of the UE itself, the UE transmits random access information to the intermediate node or the BS. The information can carry more complete information than that in the random access request, for example, a random number generated based on the low bit of the UE ID is indicated in the random access request, and the complete UE ID is indicated in the random access information;
the intermediate node or the BS receives the random access information of the UE and transmits a random access information response to the UE. The information carried in the random access information response may carry the configuration information of the UE for accessing the system and/or the configuration information required by the UE to subsequently receive the DL channel and/or transmit the UL channel.

After acquiring the random access information response, according to the information configured therein, the UE can transmit an UL channel, such as an UL channel carrying the data of inventory information, and/or the UE can receive a DL channel, such as a DL channel carrying data of an AIoT command.

Optionally, in the random access procedure, random access procedure related information is configured in the signaling used to trigger the random access procedure, including at least one of a location and/or size and/or number of resources used for at least one of the random access request, random access request response, random access information and random access information response; an identify range of the UE participating in the random access procedure.

Optionally, in the random access procedure, the intermediate node or the BS transmits a random access request response signal, which includes N payloads, respectively corresponding to the random access requests of N UEs. Optionally, the N payloads correspond to one payload total header, and the payload total header indicates a preset UE ID corresponding to the random access request response or a UE ID corresponding to broadcast. Optionally, the N payloads correspond to one payload header respectively, and each payload header indicates a UE ID which is determined based on the UE ID indicated in the random access request, and/or based on the UE ID of the node transmitting the random access request indicated in the payload header in the signal structure used by the random access request signal, and/or based on the resources used by the random access request. For example, the node is triggered to start a random access procedure. M resources of random access requests are configured, and each resource can be used to transmit a random access request. In the random access request response, the serial number of the resource is indicated in the payload header, and the payload corresponding to the indicated payload header with the serial number m is the response information of the random access request on the M-th resource. The configuration may be indicated in signaling for triggering the random access procedure.

Optionally, each payload as the random access request response information indicates at least one of:
information of the random access request corresponding to the response, such as the resources used by the random access request (which can be indicated by the serial number), or UE ID indicated in the random access request. This information can be used to distinguish which random access request the response corresponds to;
information of resources of the random access information corresponding to the response, such as resources used by the random access information, or types of data information included in random access information, such as what information is needed for inventory.

Optionally, indicating the resources used by the corresponding random access information in the payload of the random access request response information further includes at least one of the following methods:
configuring K resources used for random access information for the UE, and indicating the serial numbers of the resources in the payload;
indicating the time domain position of the resource used by the random access information in the payload, including at least one of its time domain starting position and time domain length, where the time domain starting position can be indicated by the offset from the reference point. The reference point may be the transmission time point of the random access request response, the starting position or ending position used by the actual transmission of the random access request response, the starting position or ending position of the resources configured for the random access request response (which may be a superset used by the actual transmission of the random access request response), the starting position or ending position of the resources used by the random access request, or a preset and/or (pre-)configured time point, such as a reference time point configured in the signaling for triggering random access procedure. Optionally, this method is used when the system is configured or used with TDM-based random access;
indicating the frequency domain position of the resource used by the random access information in the payload, including the frequency domain offset between the resource and a reference frequency point, where the reference frequency point includes at least one of: preset and/or (pre-)configured frequency points, central frequency points used by DL channels and central frequency points used by UL channel transmission; This method is used when the system is configured or used with FDM-based random access;
indicating the coding methods of the resources used by the random access information in the payload, including applicable coding methods such as FM0, Miller, Manchester and PIE, and further including the transmission waveform of the Miller code, such as at least one of Miller-2, Miller-4 and Miller-8. Optionally, this method is used when the system is configured or used with CDM-based random access.

Optionally, the UE transmits an UL signal and/or receives a DL signal, and an intermediate node or a BS transmits the DL signal and/or the UL signal, further including: acquiring configuration information associated with frequency hopping; transmitting an UL signal and/or receiving a DL signal or transmitting a DL signal and/or an UL signal with frequency hopping based on the configuration information.

Optionally, the configuration information associated with frequency hopping may be at least one of preset, pre-configured, and configured by the BS and/or intermediate node. The configuration information may be indicated in a broadcast channel and/or by at least one of medium access control (MAC) signaling, radio resource control (RRC) signaling, downlink control information (DCI), payload header and payload total header.

Optionally, the configuration information associated with frequency hopping includes at least one of frequency hopping pattern, bandwidth for frequency hopping, transmission using frequency hopping, transmission using configuration information associated with frequency hopping (for example, there may be multiple groups of configuration information, and the configuration information also indicates one or more groups of information are used by which transmissions respectively). Optionally, the configuration information associated with frequency hopping further includes information corresponding to UL transmission and/or DL transmission, which can be configured separately.

The information of the bandwidth used for frequency hopping includes at least one of the size of the bandwidth, the starting position in the frequency domain, the ending position in the frequency domain, the starting time point when the bandwidth is used in the time domain, and the ending time point when the bandwidth is used in the time domain. Further, the bandwidth for frequency hopping may be determined based on the reception bandwidth of the UE.

For example, the BS indicates the configuration information related to frequency hopping to the UE through the broadcast channel, including several patterns of frequency hopping and the bandwidth used for frequency hopping. Accordingly, the UE acquires the configuration information related to frequency hopping by receiving the broadcast channel. When the BS transmits a DL transmission, the BS dynamically indicates, in the payload total header in the DL transmission, whether the DL transmission is transmitted by the BS with frequency hopping. The UE can determine whether the DL transmission is transmitted by the

BS with frequency hopping based on the indication of the received payload total header. The payload total header is not transmitted with frequency hopping, and the rest information in the DL transmission is transmitted with frequency hopping, so that the UE can receive the payload total header at a fixed frequency point and receive the rest information in the DL transmission according to the indications in the payload total header.

For example, the BS indicates the configuration information related to frequency hopping to the UE through the broadcast channel. When the BS schedules the UL transmission of the UE, the BS dynamically indicates whether the UL transmission is transmitted by the UE with frequency hopping in the scheduling signaling. Accordingly, the UE acquires the configuration information related to frequency hopping by receiving the broadcast channel. When transmitting the UL transmission, the UE determines whether to transmit it with frequency hopping based on its scheduling information.

For example, the BS indicates the configuration information related to frequency hopping to the intermediate nodes through the broadcast channel. When the BS schedules the UL transmission of the UE based on backscattering, the BS will also schedule the intermediate node to transmit the carrier wave (CW) for the UE to backscatter, and dynamically indicate in the scheduling signaling transmitted to the intermediate node whether the CW is transmitted by the intermediate node with frequency hopping. Correspondingly, the intermediate node acquires the configuration information related to frequency hopping by receiving the broadcast channel. It is determined whether to transmit the CW with frequency hopping based on its scheduling information. When the CW is transmitted with frequency hopping, the UE can perform no frequency hopping and directly perform backscattering on the frequency hopped CW, and the generated UL transmission is still transmitted with frequency hopping.

To improve the reliability of physical layer transmission, a cyclic redundancy check (CRC) can be attached to the data bits as a checking means for the physical layer to detect whether the decoded data bits are wrong.

Optionally, the signal structure also includes at least one CRC, and the signal/channel/information/signal structure corresponding to the CRC includes at least one of control information, data, a payload total header, at least one payload header, all payload headers, a payload total header and all or at least one payload header, at least one payload, all payloads, a payload total header and all payload headers and all payloads, and at least one of the above-mentioned items in the signal structure and/or at least one of the above-mentioned items before or after the midamble in the signal structure, such as all payloads after the midamble, and the payload total header and all payload headers and all payloads before the midamble.

The midamble includes at least one of an SS transmitted in the middle of a payload header, an SS transmitted in the middle of a payload, an SS transmitted between two payload headers, an SS transmitted between two payloads, an SS transmitted between a payload header and a payload, and an SS transmitted at a non-starting or ending position in the signal structure.

Optionally, the CRC included in the signal structure may correspond to one or more lengths, and to one or more generating polynomial, that is, to one or more methods for generating CRC. When corresponding to multiple, which length/polynomial/generating method to use can be determined based on the signal/channel/information/signal structure corresponding to CRC, and/or determined according to the channel type corresponding to the signal structure (for example, UL or DL channel, control or data channel), and/or determined according the length of the signal structure or the length of the signal/channel/information/signal structure corresponding to CRC (for example, whether the number of bits of information corresponding to CRC exceeds a threshold value corresponds to different CRC lengths/polynomials/generating methods), and/or determined according to the configured/preset information, and/or determined according to the information indicated in at least one of the control information, the payload total header and the payload header.

There may be no midamble in a signal structure, which includes a CRC corresponding to the payload total header and all payload headers and all payloads, and the generating polynomial of the CRC is the first polynomial. There may be a midamble in another signal structure, which includes a CRC corresponding to the payload total header and all payload headers and all payloads before the midamble, and a CRC corresponding to all payloads after the midamble, and the generating polynomials of the two CRCs are the second polynomials. The generating polynomial of the CRC is determined based on whether there is a midamble and the relationship between the signal/channel/information/signal structure corresponding to CRC and the midamble.

Herein, the SS can be used to achieve synchronization and always calibrate. The SS can also be replaced by a signal for channel measurement. The SS or the signal used for channel measurement can be a preset signal with a specific sequence or waveform, which is used for the receiving node to receive it and acquire/calibrate the synchronization or measure the channel state based on the difference between the received signal and the preset signal.

The control information may include a payload total header, at least one payload header or all payload headers, at least one payload corresponding to control information, a payload corresponding to a physical layer control channel or signal, and/or a payload corresponding to a higher layer control channel or signal. The data may include at least one payload or all payloads, the payload corresponding to the data channel and/or the payload corresponding to the higher layer control channel or signal, and may exclude the payload corresponding to the physical layer control channel or signal.

The payload in the signal structure includes a payload corresponding to a physical layer control channel or signal, and the physical layer control channel or signal includes at least one of a signal/channel for indicating control information for DL transmission of the AIoT, a signal/channel for indicating the control information of the UL transmission of the AIoT, and a scheduling request (SR).

The broadcast channel may also be replaced by a broadcast signal, and the broadcast channel and/or the broadcast signal may be transmitted through a data channel. For example, in the system, unicast data transmitted to one terminal, groupcast data transmitted to multiple terminals and broadcast data transmitted to all terminals are transmitted in the same physical layer channel, which is called data channel; further, the types of information indicated in the data channel can be distinguished as unicast, groupcast and broadcast by additional methods such as an indication in the control information, an indication of the ID of the receiver, and a sequence indication.

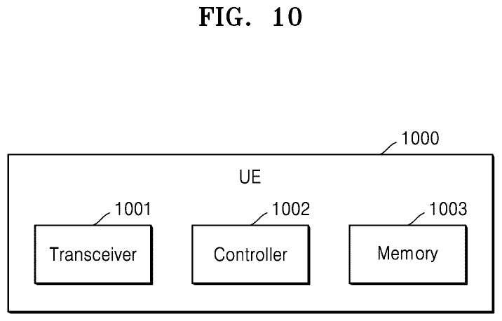

FIG. 10 illustrates a configuration of a UE 1000 according to an embodiment.

Referring to FIG. 10, the UE 1000 may include a transceiver 1001 and a controller 1002. The UE 1000 may further include memory 1003. For example, the transceiver 1001 may be configured to transmit and receive signals. For example, the controller 1002 may be coupled to the transceiver 1001 and configured to execute one or more instructions stored in the memory 1003 to perform the aforementioned methods.

The memory 1003 may store programs for processing and control by the at least one processor 1002 and may store data input to or output from the UE 1000. The memory 1003 may include at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc.

The processor 1002 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

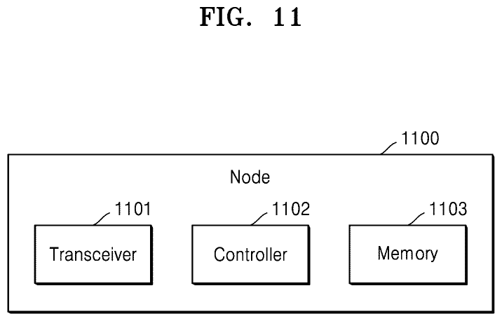

FIG. 11 illustrates a configuration of a node 1100 according to an embodiment.

Referring to FIG. 11, the node 1100 may include a transceiver 1101 and a controller 1102. The node 1100 may further include memory 1103. For example, the transceiver 1101 may be configured to transmit and receive signals. For example, the controller 1102 may be coupled to the transceiver 1101 and configured to execute one or more instructions stored in the memory 1103 to perform the aforementioned methods.

The memory 1103 may store programs for processing and control by the at least one processor 1102 and may store data input to or output from the node 1100. The memory 1103 may include at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc.

The processor 1102 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in the present application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may variously implement the described functional sets for each specific application, but such design decisions should not be interpreted as causing a departure from the scope of the disclosure.

The various illustrative logic blocks, modules, and circuits described in the present application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, more than one microprocessors, one or more microprocessors cooperating with a DSP core, or any other such configuration.

The steps of the method or algorithm described in the present application may be embodied directly in hardware, in a software module executed by a processor, or in a combination thereof. The software module may reside in RAM memory, flash memory, ROM memory, erasable programmable ROM (EPROM) memory, electrically erasable programmable ROM (EEPROM) memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

The functions herein may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

The above description is only an exemplary implementation of the present invention, and is not intended to limit the scope of protection of the present invention.

In addition, computer-readable storage media may be provided in the form of non-transitory storage media. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

What is claimed is:

1. A method performed by a user equipment (UE) in an AIoT (Ambient Internet of Things) system, comprising:
receiving at least one payload header in a downlink signal, wherein the at least one payload header includes information related to an identity of the UE; and
receiving at least one payload corresponding to the at least one payload header in the downlink signal based on the information related to the identity of the UE.

2. The method of claim 1, wherein the downlink signal includes a payload total header including at least one of:
information related to an identity of at least one UE that receives the downlink signal;
information related to an identity of a node that transmits the downlink signal;
information related to a number of the at least one payload header;
information related to a number of the at least one payload;
information related to a length of one or more of the at least one payload header;
information related to a type of one or more of the at least one payload header;
information related to a total length of the downlink signal;
information related to a total length of the payload total header and the at least one payload header;
information related to a total length of the at least one payload header; or
information related to a total length of the at least one payload.

3. The method of claim 2,
wherein the payload total header is transmitted at a start position of the downlink signal or before the at least one payload header and the at least one payload.

4. The method of claim 1,
wherein the downlink signal includes a first indicator that indicates a start position of a payload header, and
the first indicator is transmitted at least one of:
a start position of one or more or each of the at least one payload header;
a start position of a first payload header of the at least one payload header; or
a start position of the payload total header.

5. The method of claim 1, wherein the downlink signal includes a second indicator that indicates an end position of a payload header, and
the second indicator is transmitted at least one of:
an end position of one or more or each of the at least one payload header;
an end position of a last payload header of the at least one payload header; or
an end position of the payload total header.

6. The method of claim 1, wherein the downlink signal includes a third indicator that indicates a start position of a payload, and
the third indicator is transmitted at least one of:
a start position of one or more or each of the at least one payload; or
a start position of a first payload of the at least one payload.

7. The method of claim 1, wherein the downlink signal includes a fourth indicator that indicates an end position of a payload, and
the fourth indicator is transmitted at least one of:
an end position of one or more or each of the at least one payload; or
an end position of a last payload of the at least one payload.

8. The method of claim 1, wherein the downlink signal includes a synchronization signal that is transmitted at least one of:
a start position of the downlink signal;
a position in a middle of any payload header in the downlink signal;
a position in a middle of any payload in the downlink signal;
a position between any payload header in the downlink signal and a payload header before or after the any payload header;
a position between any payload in the downlink signal and a payload before or after the any payload; or
a position between any payload header in the downlink signal and a payload before or after the any payload header.

9. The method of claim 1,
wherein the at least one payload header indicates that an information bit after the at least one payload header corresponds to another payload header or a corresponding payload.

10. The method of claim 2,
wherein the payload total header indicates information related to identities of all receiving nodes corresponding to the downlink signal, and
wherein the at least one payload header indicates information related to an identity of a receiving node corresponding to a payload corresponding to the at least one payload header.

11. A method performed by a user equipment (UE) in an AIoT (Ambient Internet of Things) system, comprising:
determining at least one payload header in an uplink signal, wherein the at least one payload header includes information related to an identity of an intermediate node or a base station; and
transmitting the uplink signal based on the information related to the identity of the intermediate node or the base station, wherein the uplink signal includes the at least one payload header and at least one payload corresponding to the at least one payload header.

12. A user equipment (UE) in an AIoT (Ambient Internet of Things) system, comprising:
memory storing one or more instructions; and
at least one processor; wherein the at least one processor is configured to execute the one or more instructions stored in the memory to:
receive at least one payload header in a downlink signal, the at least one payload header including information related to an identity of the UE; and
receive at least one payload corresponding to the at least one payload header in the downlink signal based on the information related to the identity of the UE.

13. A node in an AIoT (Ambient Internet of Things) system, comprising:
memory storing one or more instructions; and
at least one processor; wherein the at least one processor is configured to execute the one or more instructions stored in the memory to:
transmitting at least one payload header in a downlink signal, the at least one payload header including information related to an identity of an intermediate node and/or a base station; and
transmitting at least one payload corresponding to the at least one payload header in the downlink signal based on the information related to the identity of the intermediate node and/or the base station.

14. The node of claim 13, wherein the downlink signal includes a payload total header including at least one of:
information related to an identity of at least one UE that receives the downlink signal;
information related to an identity of a node that transmits the downlink signal;
information related to a number of the at least one payload header;
information related to a number of the at least one payload;
information related to a length of one or more of the at least one payload header;
information related to a type of one or more of the at least one payload header;
information related to a total length of the downlink signal;
information related to a total length of the payload total header and the at least one payload header;
information related to a total length of the at least one payload header; or
information related to a total length of the at least one payload.

15. The node of claim 14,
wherein the payload total header is transmitted at a start position of the downlink signal or before the at least one payload header and the at least one payload.

16. The node of claim 13,
wherein the downlink signal includes a first indicator that indicates a start position of a payload header, and
the first indicator is transmitted at least one of:
a start position of one or more or each of the at least one payload header;
a start position of a first payload header of the at least one payload header; or
a start position of the payload total header.

17. The node of claim 13, wherein the downlink signal includes a second indicator that indicates an end position of a payload header, and
the second indicator is transmitted at least one of:
an end position of one or more or each of the at least one payload header;
an end position of a last payload header of the at least one payload header; or
an end position of the payload total header.

18. The node of claim 13, wherein the downlink signal includes a third indicator that indicates a start position of a payload, and
the third indicator is transmitted at least one of:
a start position of one or more or each of the at least one payload; or
a start position of a first payload of the at least one payload.

19. The node of claim 13, wherein the downlink signal includes a fourth indicator that indicates an end position of a payload, and
the fourth indicator is transmitted at least one of:
an end position of one or more or each of the at least one payload; or
an end position of a last payload of the at least one payload.

20. The node of claim 13, wherein the downlink signal includes a synchronization signal that is transmitted at least one of:
a start position of the downlink signal;
a position in a middle of any payload header in the downlink signal;
a position in a middle of any payload in the downlink signal;
a position between any payload header in the downlink signal and a payload header before or after the any payload header;
a position between any payload in the downlink signal and a payload before or after the any payload; or
a position between any payload header in the downlink signal and a payload before or after the any payload header.
